(19) United States
(12) Patent Application Publication
(10) Pub. No.: US 2008/0238075 A1
(43) Pub. Date: Oct. 2, 2008

(54) Method and Device for Control of a Reversible Belt Tensioner

(75) Inventors: Wilfried Bullinger, Korntal-Muenchingen (DE); Walter Eberle, Hochdorf (DE); Karl Moehle, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STUTTGART (DE)

(21) Appl. No.: 11/886,003

(22) PCT Filed: Feb. 24, 2006
(86) PCT No.: PCT/EP2006/001731

§ 371 Date: Apr. 8, 2008

(30) Foreign Application Priority Data
Mar. 10, 2005 (DE) 10 2005 010 997.7

(51) Int. Cl. B60R 22/46; B60R 22/48

(52) U.S. Cl. 280/806; 701/45

(57) ABSTRACT

In a method for controlling a reversible seatbelt pretensioner of a vehicle, characteristic variables of the accelerator pedal and brake are acquired and monitored with respect to a reaction of the driver to a critical situation in the form of release of the accelerator pedal and subsequent actuation of the brake. When a reaction of a driver to a critical situation is identified, the seatbelt pretensioner is activated.

### BACKGROUND AND SUMMARY OF THE INVENTION

This invention relates to a method for controlling a reversible seatbelt pretensioner of a vehicle, in particular for activating the seatbelt pretensioner when a critical situation is identified. Furthermore, the invention relates to a reversible seatbelt pretensioner with a control unit for carrying out the method.

In contemporary vehicles, restraint means which can be actuated, for example a seatbelt pretensioner, are used to alleviate the consequences of accidents for a vehicle occupant. Methods for controlling a seatbelt pretensioner are known from practice.

German document DE 100 05 010 A1 discloses, for example, a method for restraining a vehicle occupant on a vehicle seat by actuating a reversible vehicle occupant protection system. In this context, driving state data are acquired using a sensor system. If a critical driving state is detected, characterized by an identified emergency braking operation, the vehicle occupant protection system is triggered before the collision time and placed in an operative position. In this context, the vehicle occupant is moved into the vehicle seat with a specific force by means of a reversible seatbelt pretensioner, and is held on the vehicle seat in a pulled-back position with a restraining force. This restraining force persists during the detected critical driving state. The critical driving situation is acquired using driving state data such as steering angle, wheel speed, yaw rate and acceleration. Evaluation of the actuation of the accelerator pedal and/or brake pedal can also serve, in addition to the driving state data such as, for example, the relative velocity and the distance from the vehicle or object which is traveling ahead or is stationary, as a further triggering criterion for the reversible seatbelt pretensioner.

The brought-forward activation of the reversible seatbelt pretensioner brings about a reduction in the severity of the consequences of an impact since the vehicle occupant then only has a minimum inertia-acceleration travel distance within the seatbelt so that the deceleration forces are minimized.

German document DE 101 21 386 C1 discloses a further method for actuating a reversible vehicle occupant protection means which, when the state of “emergency braking” is identified, moves a reversible vehicle occupant protection into an operative position means before the collision time. In this context, the direction from which a maximum hazard can be expected is acquired from driving state data using the states of emergency braking, understeering and oversteering, with the vehicle occupant protection system being actuated in such a way that the protective effect occurs in accordance with the direction of maximum hazard.

In general, in the known methods the detection of an emergency braking operation is necessary, for example, when using a predefined change in the brake pedal (also referred to as BAS threshold for short). The threshold values which serve to detect the emergency braking operation, for example the BAS threshold, are frequently not reached in this context, as a result of which, despite a critical situation, the reversible seatbelt pretensioner is not activated and the brake system is not preconditioned. The driving state data which is also acquired, such as the relative velocity and data relating to the surroundings, for example distance from another vehicle, require costly measuring devices. Such a measuring process is relatively slow due to the data relating to the surroundings being taken into account so that valuable reaction time is lost.

The invention is therefore based on the object of specifying an improved method for controlling a seatbelt pretensioner and a seatbelt pretensioner by means of which the consequences of an impact for a vehicle occupant are alleviated.

The object is achieved according to the invention by means of a method and a seatbelt pretensioner having features claimed.

Advantageous developments of the invention are the subject matter of dependent claims. The invention relates in particular to actuation of the seatbelt pretensioner as a preventive measure.

The invention provides for characteristic variables of the accelerator pedal and brake to be acquired and to be monitored for interaction, which is used to identify a reaction of a driver to a critical situation, with the seatbelt pretensioner being activated if there is a reaction of a driver to a critical situation. The advantage of the method according to the invention is that a reaction of a driver to a critical situation, for example the initiation of an emergency braking operation, is identified particularly quickly and reliably by analyzing driver reactions using a sensor system which is already present in the vehicle and without taking into account data relating to the surroundings, so that early actuation of a reversible seatbelt pretensioner is triggered. As a result, preventive activation of the seatbelt pretensioner before a possible collision is ensured. Such predictive activation of the seatbelt pretensioner in a critical situation permits the severity of the consequences of an impact to be reduced. The method according to the invention makes it possible to detect a critical situation particularly quickly and at low cost simply using vehicle data or vehicle characteristic variables. Only a small amount of data is required and said data can be measured quickly and made available in vehicles after having been conditioned with an electronic bus system (CAN).

In one possible configuration of the method, the accelerator pedal is monitored for activation and/or actuation using at least one or more associated characteristic variables. If activation and/or actuation of the accelerator pedal is identified, the respective characteristic variable is compared with an associated accelerator pedal threshold value. In this context, the actuation of the accelerator pedal is monitored in two stages; in a first stage the position of the accelerator pedal is monitored as a characteristic variable with respect to a pedal value which is greater than zero or to determine whether a first lower accelerator pedal threshold value is exceeded. If the value of the accelerator pedal remains below the accelerator pedal threshold value or the pedal value is equal to zero, the seatbelt pretensioner remains deactivated. Otherwise, in a second stage the pedal value is monitored to determine whether a second upper accelerator pedal threshold value is reached or exceeded. If the first accelerator pedal threshold value is exceeded and the second accelerator pedal threshold value is undershot, the seatbelt pretensioner remains deactivated. If the second accelerator pedal threshold value is exceeded, it is concluded that the driver has carried out a reflex-like release actuation of the accelerator pedal, and a suspicion of a critical situation is thus identified. In other words: the two-stage threshold value analysis permits simple and thus rapid identification of a sudden release of the accelerator pedal. In this context, the type of actuation of the accelerator pedal is analyzed in more detail. For example, the speed with which the accelerator pedal is moved into an enabling position by being released is used for the analysis. The speed of the change in pressure which is caused by the release of the accelerator pedal can also be acquired and monitored to determine whether an associated and predefined threshold value is reached or exceeded.

A further configuration provides that when the second accelerator pedal threshold value is reached and/or exceeded a monitoring period up to the initiation of an actuation of a brake pedal is started. For this purpose, one of the characteristic variables of the brake is monitored for activation or actuation of the brake, continuously or at least during the monitoring period. In this way, a change of pedal from the accelerator pedal to the brake pedal can be acquired sufficiently precisely, particularly simply and very quickly.

In order to identify a possible critical situation, after actuation of the brake has been identified the respective characteristic variable of the brake is monitored to determine whether an associated brake pedal threshold value is reached or exceeded. Alternatively or additionally one of the characteristic variables, for example the brake light, can be monitored for activation. A plurality of characteristic variables of the brake can also be monitored simultaneously to determine whether it is activated and/or exceeds and/or is below a threshold value. Such monitoring and analysis of the behavior of the brake permits rapid and simple identification of a possible hazardous situation or emergency situation which, for example, makes an emergency braking operation necessary. In this context, the behavior of the brake and the type of actuation of the brake are analyzed in more detail by the driver. For example, the speed with which the brake pedal is activated is used for the analysis. The speed of the change in pressure which is caused by the actuation of the brake pedal can also be acquired and be monitored to determine whether an associated and predefined threshold value is reached or exceeded.

In a further configuration, the monitoring period is stopped if the brake pedal threshold value is reached and/or exceeded and/or if one of the characteristic variables of the brake is activated. Furthermore, the stopped monitoring time is checked to determine whether the time value is below a predefined time threshold value, in which case, when the monitoring period for the change from the accelerator pedal to the brake pedal, and thus for the actuation of the brake pedal is undershot, a reaction of the driver to a critical situation, for example an accident situation or hazardous situation, is identified. The interaction of the accelerator pedal and brake pedal to the presence of a hazardous situation or emergency situation is monitored in a simple way using the analysis of the monitoring period. In particular, rapid, reflex-like changes in the actuation of the accelerator pedal and/or of the brake pedal can be identified quickly and reliably. In order to determine precisely the presence and the type of the hazardous situation or emergency situation, a differentiation is made between briefly tapping the brake pedal and strong and permanent actuation of the brake pedal or briefly releasing or rapid and permanent release of the accelerator pedal by virtue of the fact that a precise chronological and characteristic-variable-related analysis of the change between pedals is carried out.

If a reaction to a critical situation is identified, the seatbelt pretensioner is automatically activated. The seatbelt pretensioner can be activated briefly or for a long time depending on the type of actuation and the embodiment of the actuation means. The type of activation of the seatbelt pretensioner is determined here by the type of identified critical situation. For example, if a brief critical situation is identified and is present, for example a panic reaction, only brief activation of the seatbelt pretensioner may be necessary. The seatbelt pretensioner can also be activated in intervals so that the driver is made aware of a possible critical situation.

Advantageously, a position and/or a release speed and/or a release acceleration of the accelerator pedal are acquired as characteristic variables of the accelerator pedal (also referred to as accelerator pedal value). These characteristic variables can easily be measured quickly, in particular in a vehicle with a conventional sensor system, and in a vehicle which is equipped with a CAN bus they are also easily and quickly transmitted to a control unit for activating the seatbelt pretensioner.

Preferably a position and/or an actuation speed of the brake pedal and/or a switched state of a brake light and/or a brake pressure are acquired as characteristic variables of the brake (also referred to as brake pedal value). These characteristic variables can also be measured in a vehicle by means of a conventional sensor system and are easily and quickly transmitted to the control unit for the seatbelt pretensioner via the CAN bus.

In a further possible configuration of the invention, the seatbelt pretensioner remains deactivated as long as the vehicle's own velocity is less than a velocity threshold value. As a result, the seatbelt pretensioner is activated only in situations with a high hazard potential.

In addition to the activation of the seatbelt pretensioner when a critical situation is identified, a braking assistance operation is carried out if the seatbelt pretensioner is activated. In this way, the advantages of the enhanced braking effect are combined with an optimum braking distance and the early activation of the seatbelt pretensioner in order to reduce the severity of a possible accident, in particular the severity of the consequences of an impact.

In addition, data from a surrounding sensor system can be taken into account, for example for plausibility checking of the presence of a critical situation. For example, at least one of the threshold values is set dynamically using the data from the surrounding sensor system. As a result, the reliability of the identification of a critical situation is increased.

In one particular configuration, a relative velocity and/or a distance from a vehicle which is traveling ahead or traveling behind are acquired as data of the surrounding sensor system. As a result, both the brake pedal threshold values and the accelerator pedal threshold values can be adapted to the chronological intervals and spatial distances between the driver's own vehicle and vehicles traveling ahead, in particular in relation to the currently expected braking distance and the reaction time of the driver of vehicle in question.

The invention also provides a reversible seatbelt pretensioner with a control unit, in which case the control unit monitors characteristic variables of the accelerator pedal and brake for a release of the accelerator pedal and subsequent actuation of the brake, and it automatically activates the seatbelt pretensioner if a reaction of a driver to a critical situation can be identified in this context.

The exemplary embodiments of the invention are explained in more detail with reference to the drawings.

### BRIEF DESCRIPTION OF THE DRAWINGS

FIG. 1 is a block circuit diagram of a seatbelt pretensioner with a control unit, and

FIGS. 2a and 2b are flowcharts of a method for controlling the seatbelt pretensioner.

### DETAILED DESCRIPTION OF THE INVENTION

Parts which correspond to one another are provided with the same reference symbols in all the figures.

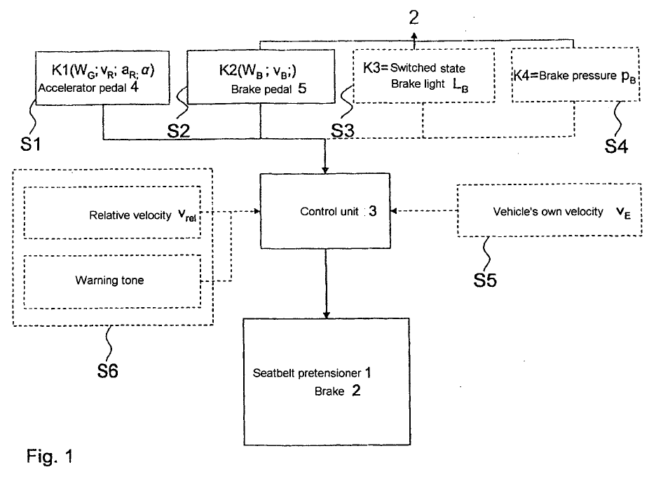

FIG. 1 is a block illustration of a reversible seatbelt pretensioner 1 of a vehicle (not illustrated in more detail) which has a brake 2. The seatbelt pretensioner 1 and brake 2 are controlled by means of a control unit 3. Depending on the type and design, the brake 2 and the seatbelt pretensioner 1 can each have an associated control unit 3.

For rapid and early, in particular predictive activation of the seatbelt pretensioner 1 in the event of a critical situation, for example a possible accident situation or hazardous situation, the control unit 3 is connected to a number of sensors S1 to Sn which acquire characteristic variables K1 to Kn of the accelerator pedal 4 and of the brake 2 of the vehicle.

For example the position W_{G} of the accelerator pedal, the release speed v_{R} and/or the release acceleration a_{R} of the accelerator pedal 4 are acquired as a characteristic variable K1 of the accelerator pedal 4 (also referred to as accelerator pedal value). The position W_{G} of the accelerator pedal is acquired here in a range from idling to fully opened throttle, for example. In order to acquire the position W_{G} of the accelerator pedal, the release speed v_{R} and/or the release acceleration a_{R}, the sensor S1 is embodied, for example, as a potentiometer or as a pressure sensor. The speed of the change in pressure when the accelerator pedal 4 is actuated is determined by means of the pressure sensor. Further sensors can also be provided in the form of position sensors for acquiring the position of the accelerator pedal 4 in one of the end positions—fully open throttle position or accelerator pedal-releasing end position—or for acquiring the angular position of the accelerator pedal 4.

Various measurement variables of components of the brake 2 are acquired as characteristic variables K2 to K4 of the brake 2. For example, the brake pedal position W_{B} and/or the actuation speed v_{B} of the brake pedal 5 (also referred to as brake pedal values) are acquired, for example, as a characteristic variable K2 of the brake 2 for the brake pedal 5.

During operation of the vehicle, the interaction between the accelerator pedal 4 and brake pedal 5 is determined by means of the control unit 3 using the acquired characteristic variables K1 and K2 for the accelerator pedal 4 or the brake pedal 5, and analysis of and monitoring for a reaction of a driver to a critical situation are carried out. If a driver reaction which represents a critical situation is identified, the seatbelt pretensioner 1 is automatically activated.

In other words: the control unit 3 monitors the speed of changes of pedal between the accelerator pedal 4 and brake pedal 5 using the position W_{G} of the accelerator pedal 4 and the position W_{B} of the brake pedal 5, or using the actuation speeds of the pedals. If a change of pedal occurs at a high speed, a reaction of the driver to a critical situation is identified and the reversible seatbelt pretensioner 1 is activated. If appropriate, it is also possible to activate a braking assistance operation so that the brake pressure p_{B} on the brake 2 lies in the control range of the antilock brake system of the vehicle, as a result of which an optimum braking distance is achieved. Both activation processes—activation of the seatbelt pretensioner 1 and pre-conditioning of the brake 2—serve to provide preventive vehicle occupant protection by virtue of the rapid and predictive identification of a critical situation, and they may be an integral component of what is referred to as a pre-safe system.

In extended configurations, it is alternatively or additionally possible to use the switched state L_{B} of the brake light and/or the brake pressure p_{B} as characteristic variables K3 and K4 for the monitoring for a rapid change of pedal. The respective sensors S2 to S4 of the brake 2 are conventional sensors for measuring the braking torque, the braking force, or set point deceleration, for example brake sensors, potentiometers or position sensors.

A further embodiment provides for the seatbelt pretensioner 1 to remain deactivated if the vehicle itself is moving at a low velocity v_{E}, for example slower than 10 km/h. Unnecessary activation of the seatbelt pretensioner 1 is thus avoided. For this purpose, the vehicle's own velocity v_{E} is acquired by means of suitable sensors S5 and fed to the control unit 3.

Furthermore it is possible to use for the monitoring the relative velocity vᵣₑₗ of the vehicle which is acquired by means of a surrounding sensor system S6 and/or the switched state of an associated warning tone, in order to adapt the behavior of the control of the seatbelt pretensioner 1 to surrounding conditions such as chronological and spatial distances between the driver's own vehicle and surrounding vehicles or objects.

In a vehicle which is embodied with what is referred to as an E-gas control system in which, for example, the throttle valve in the case of a petrol engine or the injection system in the case of a diesel engine is no longer actuated mechanically but rather electrically by means of the accelerator pedal 4, the characteristic variables K1 to K4 which are referred to as pedal values are transmitted via the CAN bus. The control unit 3 acquires the necessary data in this context.

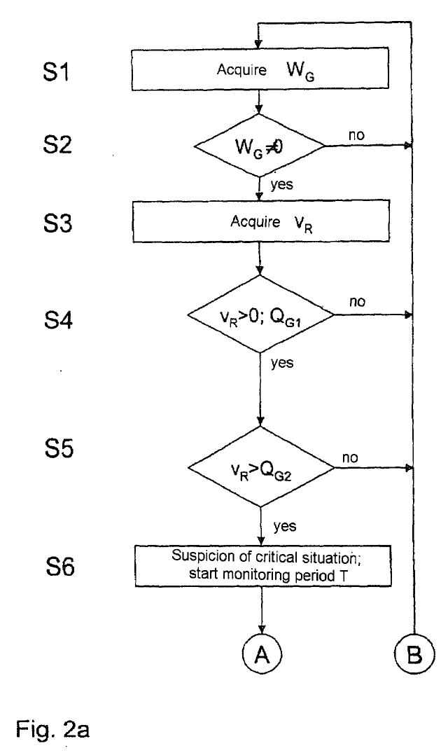

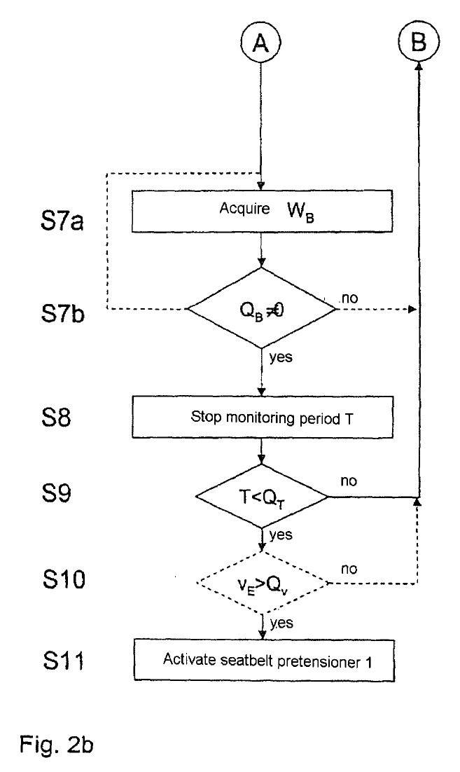

A possible exemplary embodiment of a flowchart of a method for actuating the seatbelt pretensioner 1 is illustrated in FIGS. 2a and 2b as a function of the change of pedal between the accelerator pedal 4 and brake pedal 5.

In step S1, the position W_{G} of the accelerator pedal 4 is acquired, for example, as a characteristic variable K1. In step S2, it is checked, using the position W_{G}, whether the accelerator pedal 4 is actuated. If it is not actuated, the method is started again at step S1.

In step S3, the release speed v_{R} of the accelerator pedal 4 is additionally acquired. In step S4, it is checked whether the release speed v_{R} which is acquired as a pedal value exceeds a value which is greater than zero or a first lower accelerator pedal threshold value Q_{G1}. If the pedal value remains below the accelerator pedal threshold value Q_{G1} and the pedal value is greater than or equal to zero, the method is carried out again starting at step S1. The seatbelt pretensioner 1 is not activated.

Otherwise, in step S5 the characteristic variable of the release speed v_{R} is checked, in a second stage, to determine whether a second upper accelerator pedal threshold value Q_{G2} is reached or exceeded. The second upper accelerator pedal threshold value Q_{G2} is larger in this example than the first accelerator pedal threshold value Q_{G1}.

If the upper accelerator pedal threshold value Q_{G2} is not reached or not exceeded, the method is carried out again starting at step S3 or step S1. In a way which is not illustrated in more detail it is also possible to provide a chronological abort condition so that after a predefinable repetition period of the steps S3 to S5 the program flow is interrupted and the method is started again at step S1, because, for example, the accelerator pedal 4 has not been released in an accelerated fashion. This may be carried out, for example, by means of a parallel monitoring process.

Depending on the type and design of the method, the threshold value analysis for the pedal value can be carried out in a plurality of stages. A two-stage threshold value analysis is illustrated by way of example.

If the upper accelerator pedal threshold value Q_{G2} is then exceeded, a reflex-like release of the accelerator pedal 4 is then identified in step S6, and as a result of this a suspicion of a critical situation is identified and a monitoring period T for measuring the time of the change of pedal between the accelerator pedal 4 and the brake pedal 5 is started.

In steps S7a and S7b, the position W_{B} of the accelerator pedal 5 is acquired as a characteristic variable K2 and it is checked whether the latter exceeds a brake pedal threshold value Q_{B}. If this is not the case because the brake pedal 5 is not actuated, or not yet actuated, the steps S7a and S7b are repeated in the represented embodiment until the condition is met, and otherwise the method is continued at step S8.

Here too, a chronological abort condition is implemented in a way which is not illustrated in more detail so that after a predefinable repetition period of the steps S7a and S7b the program flow is interrupted and the method is started again at step S1 because no actuation of the brakes has taken place.

If the brake pedal threshold value Q_{B} is then reached or exceeded and/or if the brake light L_{B} is activated and/or if a predefined brake pressure threshold value Q_{pB} is reached or exceeded, then the monitoring period T is stopped in step S8. The monitoring period T gives the time which has passed during the change of pedal.

In step S9 it is checked whether the monitoring period T is lower than a predefined time threshold value Q_{T} which is, for example 100 ms. If this is not the case because, for example, the change of pedal has been carried out slowly, no critical situation is present. The method is then started again from step S1.

Optionally it is possible, before the automatic activation of the reversible seatbelt pretensioner 1 in step S11 owing to the identified reaction of the driver to a critical situation, to check, in a preceding step S10, whether the vehicle's own velocity v_{E} exceeds a predefined velocity threshold value Q_{V}, for example of 10 km/h. If this is not the case, the method is started again beginning at step S1 and the seatbelt pretensioner 1 is not activated, that is to say below the velocity threshold value Q_{V} the method does not intervene in the control of the seatbelt pretensioner 1 in this example.

A number of alternative exemplary embodiments of the method for automatically activating the seatbelt pretensioner 1 as a function of the interaction between the accelerator pedal 4 and the brake pedal 5 will be listed below.

For example, in steps S3 and S4 it is possible to compare the release acceleration a_{G} with a first accelerator pedal threshold value Q_{G1}, instead of the release speed v_{G} or additionally as a characteristic variable K1 of the accelerator pedal 4. The first accelerator pedal threshold value Q_{G1} is an acceleration value in such a case.

In step S5, the position W_{G} of the accelerator pedal 4 can be checked, instead of the release speed v_{G} or additionally as a characteristic variable K1 of the accelerator pedal 4, in order to determine whether said accelerator pedal 4 is still actuated.

In step S7a and S7b it is possible to check the switched state of the brake light L_{B}, the braking force, the braking torque, the set point deceleration or the brake pressure p_{B}, instead of the position W_{B} of the brake pedal 5 or additionally as a characteristic variable K3 of the brake pedal 5, in order to detect actuation of the brake pedal 5. In the case of the brake pressure p_{B}, a pressure value is predefined as a threshold value.

In one preferred embodiment, one or more of the threshold values can be shifted dynamically using data from a surrounding sensor system S5 which acquires and outputs, for example, a relative velocity vᵣₑₗ and/or a distance from a following vehicle or a vehicle which is traveling ahead.

In addition to the automatic activation of the seatbelt pretensioner 1, the brake system can be correspondingly preconditioned.

With the method according to the invention it is possible to take into account the speed of the change of pedal, the time between the release of the accelerator pedal 4 or the exceeding of a predefinable release speed v_{G} until a predefinable travel distance at the brake pedal 5 is covered or until a predefinable brake pressure p_{B} is reached, the actuation speed of the brake pedal 5 and/or the brake pressure build up for the identification of a critical situation and when the seatbelt pretensioner 1 is activated.

1-15. (canceled)

16. A method for controlling a reversible seatbelt pretensioner of a vehicle, comprising:
acquiring characteristic variables of the accelerator pedal and brake and using the variables to determine an interaction between the accelerator pedal and brake pedal,
analyzing and monitoring the variables for a reaction of a driver to a critical situation, and
activating the seatbelt pretensioner if a driver reaction which represents a critical situation is identified.

17. The method as claimed in claim 16, further comprising using at least one of the characteristic variables to monitor the accelerator pedal for at least one of activation and actuation, and comparing one of the characteristic variables with an associated accelerator pedal threshold value when activation or actuation occurs.

18. The method as claimed in claim 17, wherein, when the accelerator pedal threshold value is at least one of reached and exceeded, at least one of the acquired characteristic variables is used to identify a suspicion of a critical situation, and a monitoring period for an actuation of the brake pedal is started.

19. The method as claimed in claim 18, wherein, during the monitoring period, or continuously, at least one of the characteristic variables of the brake is monitored for at least one of activation and actuation.

20. The method as claimed in claim 16, wherein, when the brake is at least one of activated and actuated, at least one of the characteristic variables of the brake is monitored for an associated brake pedal threshold value or for activation.

21. The method as claimed in claim 20, wherein, when the brake pedal threshold value is reached or exceeded or when one of the characteristic variables of the brake is activated, a possible critical situation is identified using the characteristic variables.

22. The method as claimed in claim 21, wherein, when the brake pedal threshold value is reached or exceeded or when one of the characteristic variables of the brake is activated, a monitoring period is stopped.

23. The method as claimed in claim 22, wherein the monitoring period is checked for undershooting of a predefined time threshold value, and when the monitoring period undershoots the predefined time threshold value, a reaction to a critical situation is identified.

24. The method as claimed in claim 16, wherein at least one of a position, a release speed, and a release acceleration of the accelerator pedal is acquired as a characteristic variable of the accelerator pedal.

25. The method as claimed in claim 16, wherein at least one of a brake pedal position, a brake pedal actuation speed, a switched state of a brake light, a brake pressure, a change in brake pressure, a braking force, and a braking torque is acquired as a characteristic variable of the brake.

26. The method as claimed in claim 16, wherein the seatbelt pretensioner remains deactivated as long as the vehicle's own velocity is less than a predefinable velocity threshold value.

27. The method as claimed in claim 16, wherein, if the seatbelt pretensioner is activated, a braking assistance operation is carried out.

28. The method as claimed in claim 16, wherein at least one threshold value is set dynamically using data relating to surroundings acquired by a surroundings sensor system.

29. The method as claimed in claim 28, wherein at least one of a relative velocity and a distance from a vehicle traveling ahead or behind is acquired as surroundings data.

30. A reversible seatbelt pretensioner comprising a control unit for carrying out a method as claimed in claim 1, wherein the control unit monitors said characteristic variables of the accelerator pedal and brake for a release of the accelerator pedal and subsequent actuation of the brake, and, if a reaction of a driver to a critical situation can be identified in this context, automatically activates the seatbelt pretensioner.
